(19) United States
(12) Patent Application Publication
(10) Pub. No.: US 2007/0247526 A1
(43) Pub. Date: Oct. 25, 2007

(54) Camera Tamper Detection

(76) Inventors: Ronald Arthur Flook, Burlington (CA); Steven Barnett Rakoff, Toronto (CA)

Correspondence Address: David J. Gaskey;Carlson, Gaskey & Olds, 400 W Maple Road, Suite 350, Birmingham, MI, 48009, US

(21) Appl. No.: 11/587,796

(22) PCT Filed: Apr. 29, 2005
(86) PCT No.: PCT/US05/14995

§ 371 Date: Oct. 27, 2006

Related U.S. Application Data
(60) Provisional application No. 60/566,717, filed on Apr. 30, 2004.

(51) Int. Cl. H04N 7/18

(52) U.S. Cl. 348/161; 348/E07.085

(57) ABSTRACT

A security system (20) includes at least one camera (22) that provides a reference image regarding an area within a field of vision (24) of the camera (22). A controller (30) determines whether a difference between at least a portion of a test image obtained by the camera (22) and a corresponding portion of the reference image indicates tampering with the camera. Disclosed examples detect a variety of tampering conditions and provide an indication of camera tampering so that corrective or preventative measures may be taken.

### BACKGROUND OF THE INVENTION

This invention generally relates to security systems. More particularly, this invention relates to security systems including cameras.

Security systems are well known and in widespread use. Many such systems include cameras for providing visible images of selected objects or areas in or around buildings, for example. Some known security systems include providing a live feed to one or more display devices to allow an individual to observe current conditions within a field of vision of the camera. Other systems include cameras that record images over time so those images can be recalled and used for investigations of criminal or unauthorized activity.

It is possible for someone to attempt to defeat the security system or at least to hinder the functionality of the security system by tampering with one or more cameras. One technique includes physically moving the camera to change its field of vision so that the camera is not able to monitor a particular area or to provide an image of a particular object, for example. Other techniques include placing a substance on the lens of the camera such as paint or grease, for example. Such a substance renders the camera out of focus or unable to provide a discernable image. Another technique is to place an object in front of the camera or at least over the lens so that the field of vision of the camera is completely blocked.

For security systems that provide a live feed to a monitor or display observed by an individual, such tampering may be readily evident to the individual responsible for watching the displays such that appropriate action may be taken. For systems that record images without providing a live feed, for example, it is not possible to detect such camera tampering under many circumstances. Additionally, even when a live feed is provided, the responsible individual may not be able to discern subtle changes caused by particular types of tampering with a camera.

There is a need for an arrangement that can detect when a camera has been tampered with because that typically is an indication that unauthorized or illegal activity is occurring or may be occurring in the near future. This invention addresses that need.

### SUMMARY OF THE INVENTION

This invention provides the ability to automatically detect when a camera has been tampered with so that appropriate corrective or preventive action may be taken. This invention provides an automated camera tampering detection arrangement that has a wide variety of uses.

An exemplary disclosed security system includes at least one camera that provides an image. A controller determines whether a difference between at least a portion of a test image from the camera and a corresponding portion of a reference image from the camera indicates tampering with the camera.

In one example, the controller determines whether the difference between the corresponding portions of the test image and the reference image is associated with some movement within a field of vision of the camera. In one example, information from a motion detector provides an indication whether movement within the field of vision of the camera is responsible for the difference between the test image and the reference image. In another example, a plurality of successive test images are acquired and differences between the test images are used to provide an indication of movement within the field of vision of the camera.

One example includes providing a signal or indication of detected camera tampering so that an appropriate response can be made.

The disclosed example embodiments provide the ability to detect camera tampering, which may be associated with ongoing unauthorized or illegal activity. Additionally, disclosed examples provide the ability to detect various types of camera tampering that may be an indication of future planned illegal activity, which provides the advantage of being able to take action to prevent such activity before it occurs.

The various features and advantages of this invention will become apparent to those skilled in the art from the following detailed description of a preferred embodiment. The drawings that accompany the detailed description can be briefly described as follows.

### BRIEF DESCRIPTION OF THE DRAWINGS

FIG. 1 schematically illustrates selected portions of a security system designed according to an example embodiment of this invention.

FIG. 2 is a flowchart diagram summarizing one example camera tampering detection technique.

### DETAILED DESCRIPTION OF THE PREFERRED EMBODIMENT

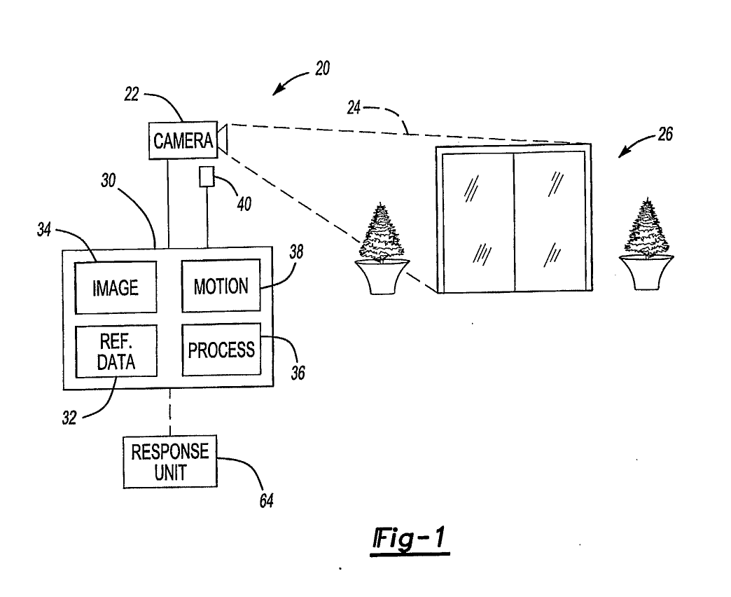

FIG. 1 schematically shows selected portions of a security system 20. A camera 22 has a field of vision 24 arranged to provide visible information regarding at least one object or an area within a building. In the illustration, an entryway 26 is within the field of vision 24 of the camera.

A controller 30 obtains information from the camera 22 using known digital signal and digital image processing techniques. In this example, the controller 30 has access to a database 32 of reference image data. At least one reference image from the camera 22 is stored in the database 32. The reference image provides a baseline of data regarding how the area or objects within the field of vision 24 of the camera 22 should appear when the camera is functioning properly and appropriately arranged to have the desired field of vision. In one example, at least one reference image is obtained when the camera is initially set into a desired orientation, properly focused and in a known operating condition.

The controller 30 periodically obtains information regarding test images from the camera 22. An image processing portion 34 of the controller 30 in one example uses known digital image processing techniques to obtain information regarding the test image or test images. A processing portion 36 of the controller 30 uses known techniques to determine whether there is a difference between at least a portion of a test image and a corresponding portion of a corresponding reference image within the database 32. When there is such a difference, that may indicate that the camera 22 has been tampered with because the portion of the test image does not match up with the corresponding portion of reference image.

Some examples utilize a selected portion of images for comparison to determine whether there is a difference indicative of camera tampering. Other examples use an entire image. This description refers to differences between images but that is intended to apply to only corresponding portions of such images, also. Given this description, those skilled in the art will be able to select appropriate portions of images to meet their particular needs. One example includes selecting a portion of the image that is unlikely to be altered by movement through the corresponding portion of the field of vision 24 or by changing light conditions.

Of course, it is possible for an individual or an object moving through the field of vision 24 of the camera 22 to cause the test image to be different than the reference image. The illustrated example includes the ability to determine whether motion within the field of vision 24 of the camera 22 is responsible for a difference between a test image and the reference image. A motion determining portion 38 in one example utilizes information regarding more than one test image taken successively within a selected period of time (e.g., five seconds) to determine whether there are differences between the test images, which would indicate movement of an individual or object through the field of vision 24 of the camera 22. For example, if an individual were walking through the entranceway 26 at the time that the test image is obtained, that individual will be in different positions within a plurality of test images taken successively over a short period of time. Such differences between the test images, determined using known digital image processing techniques in one example, provides an indication that something moving within the field of vision 24 of the camera 22 is responsible for the difference between the test image and the reference image. Under such circumstances, the controller 30 in one example determines that there is no conclusive evidence of camera tampering.

In the event that such motion is associated with camera tampering, a later-acquired test image will reveal a difference indicating tampering.

In another example, a known motion detector device 40 such as a pyroelectric sensor detects motion in an area corresponding to the field of vision 24. Appropriate signals from the motion detector 40 are used in one example by the motion determining portion 38 and the processing portion 36 for discerning whether a difference between a test image and the reference image is the result of potential camera tampering or caused by an individual or object moving through the field of vision 24 at the time that the test image was obtained.

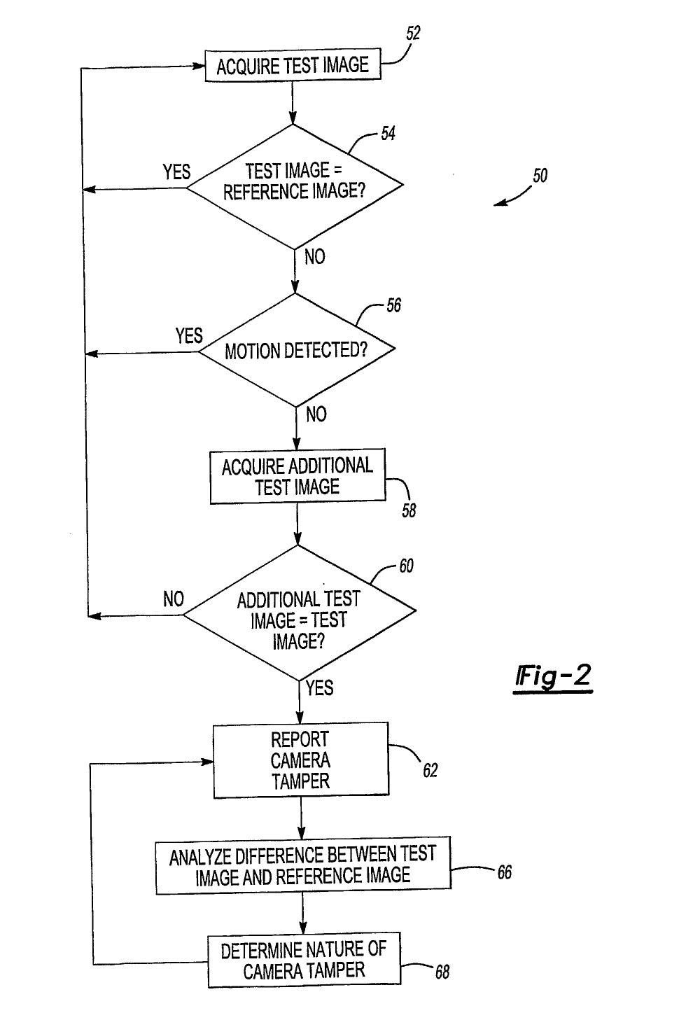

FIG. 2 includes a flowchart diagram 50 that summarizes one example approach for determining whether the camera 22 has been tampered with. At 52, a test image is acquired from the camera 22. The processing portion 36 determines whether the appropriate portion of the test image corresponds to the corresponding portion of the reference image at 54. If there is no difference between the test image and the reference image, the next test image will be acquired at 52. The time between acquiring test images may be selected to meet the needs of a particular situation.

Assuming that the test image and the reference image are somehow different, the example process of FIG. 2 continues at 56 where the controller 30 determines whether motion within the field of vision 24 is responsible for the difference between the images. Using information from a motion detector in one example allows for ruling out a difference between the test image and the reference image that is caused by something moving within the field of vision 24.

The example of FIG. 2 includes acquiring at least one additional test image at 58. A determination is made at 60 whether the additional test image is the same as the earlier test image. A difference between the additional test image and the earlier test image indicates, at least under some circumstances, that something has moved within the field of vision 24 during a time associated with acquiring the test images. In the illustrated example, if there is a difference between the additional test image and the earlier test image, the controller 30 determines that motion within the field of vision 24 is responsible for the difference between the test image and the reference image. In the event that the test images are the same, the illustrated example, that is considered an indication that nothing is moving within the field of vision 24 and that the camera has been tampered with.

One example includes obtaining a plurality of test images all within a selected period of time each time that test image information is desired. In such an example, the controller 30 determines whether there is a difference between at least one of the test images and the reference image. If there is such a difference, the controller 30 then compares at least two of the test images to determine whether the difference between the one test image and the reference image corresponds to movement within the field of vision 24. In this example, if there is no difference between the one test image and the reference image, the other test images need not be used for any particular processing at this time.

At 62, a report of the camera tamper is made to an appropriate response unit 64 (FIG. 1), so that corrective or preventive action may be taken. In one example, a tamper alarm indication provides information that there may be ongoing illegal or unauthorized activity and an appropriate response can be made. In another example, the camera tamper indication provides information for a service technician to visit the site of the camera to make any corrections, adjustments or repairs that may be necessary to ensure that the camera continues providing information regarding the desired area.

The example of FIG. 2 includes an ability to provide an indication of an expected type of camera tampering. In this example, at 66, the processing portion 36 analyzes the difference between the test image and the reference image and at least estimates a type of camera tampering that may have occurred. One example includes using known digital image processing techniques to analyze the difference between the images. Once an appropriate determination has been made or at least approximated, at 68, that determination is reported at 62 to the response unit 64. In one example, the reported, expected type of tampering can be used to determine an appropriate response.

The types of tampering that can be determined in one example include that the camera has been moved, the camera has been adjusted (e.g., placed out of focus), something is blocking at least a portion of the field of view of the camera or a substance such as grease or paint has been placed on a lens of the camera. Discerning between these different types of tampering in one example is based upon a determination whether the test image provides any information, distorted information or different information from the reference image.

When the test image does not provide any information that is associated with an indication that the camera has been turned off, blocked or covered, for example. When the test image provides different information from the reference image, that is associated with an indication that the camera has been moved. When the test image provides distorted information that is associated with an indication that the camera has been adjusted out of focus. When the amount of light associated with the test image is significantly different than that associated with the reference image, that is associated with an indication that a substance has been placed on the lens of the camera.

One example includes storing a plurality of reference images, each corresponding to a different condition that is likely to have an effect on the content of the test image. In one example, reference images for different times of day are taken and stored within the database 32. Different times of day may be associated with different lighting conditions or different shadowing effects, for example. Accordingly, one example includes obtaining different reference images for such different conditions. In one example, the controller 30 determines the time of day associated with a test image and selects an appropriate reference image for malting the determination whether the camera 22 has been tampered with. In another example, the controller 30 uses information regarding expected or actual lighting conditions for selecting the appropriate reference image for making the determination regarding potential camera tampering.

It should be noted that the various portions of the example controller 30 are schematically shown for discussion purposes. Some of the discussed functions may be accomplished using more controllers. Similarly, some of the described portions may be integrated. Those skilled in the art who have the benefit of this description will realize how to use one or more processors to accomplish the results provided by the example controller 30. Given this description, those skilled in the art will be able to select appropriate software, hardware, processors or combinations of them to realize a controller that operates consistent with the example controller 30 from this description.

As can be appreciated, the disclosed examples provide an automated system and method for determining whether a security system camera has been tampered with. The disclosed examples provide the ability for a security system to have an enhanced capability of recognizing ongoing illegal or unauthorized activity or conditions that may indicate that such activity is planned. In either event, the disclosed examples allow a security system operator to ensure that the security system is continually providing the desired amount of information for establishing the desired level of security.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1-20. (canceled)

21. A method of operating a security system having at least one camera, comprising:
determining whether a difference between at least a portion of a test image from the camera and a corresponding portion of a reference image from the camera is associated with some movement within a field of vision of the camera; and
determining whether the difference between the portion of the test image and the reference image indicates tampering with the camera.

22. The method of claim 21, comprising detecting motion in an area corresponding to the field of vision of the camera approximately when obtaining the test image.

23. The method of claim 21, comprising obtaining at least one subsequent test image and determining whether there is a second difference between at least corresponding portions of the test image and the subsequent test image.

24. The method of claim 23, comprising obtaining a plurality of test images within a selected time and using at least two of the plurality of test images for determining whether the second difference exists if there is a difference between the portions of the reference image and the test image.

25. The method of claim 21, comprising providing an indication of an alert condition when the determined difference indicates tampering with the camera.

26. The method of claim 21, comprising determining whether the tampering is at least one of moving the camera, adjusting the camera, blocking the camera, placing a substance on a lens of the camera, placing an object in front of the camera or turning off the camera.

27. A method of operating a security system having at least one camera, comprising
obtaining a plurality of reference images from the camera corresponding to a plurality of different conditions;
determining which of the conditions exists when obtaining a test image from the camera;
selecting one of the reference images corresponding to the condition existing when obtaining the test image; and
determining whether a difference between at least a portion of the test image and a corresponding portion of the selected reference image indicates tampering with the camera.

28. The method of claim 27, wherein the conditions comprise times of day and the method includes determining a time of day associated with the test image.

29. The method of claim 27, wherein the conditions comprise lighting conditions and the method includes determining an expected one of the lighting conditions associated with the test image.

30. The method of claim 27, comprising providing an indication of an alert condition when the determined difference indicates tampering with the camera.

31. The method of claim 27, comprising determining whether the tampering is at least one of moving the camera, adjusting the camera, blocking the camera, placing a substance on a lens of the camera, placing an object in front of the camera or turning off the camera.

32. A security system, comprising:
at least one camera that provides an image; and
a controller that determines whether a difference between at least a portion of a test image from the camera and a corresponding portion of a reference image from the camera is associated with some movement within a field of vision of the camera and determines whether the difference between the portion of the test image and the reference image indicates tampering with the camera.

33. The system of claim 32, comprising at least one motion detector for detecting motion in an area corresponding to the field of vision of the camera and wherein the motion detector provides an indication of motion to the controller responsive to detecting motion in the area.

34. The system of claim 32, wherein the controller uses at least one subsequent test image from the camera and determines whether there is a second difference between at least corresponding portions of the test image and the subsequent test image.

35. The system of claim 34, wherein the camera provides a plurality of test images within a selected time and the controller uses at least two of the plurality of test images for determining whether the second difference exists if there is a difference between the portions of the reference image and the test image.

36. The system of claim 32, wherein the controller provides an indication of an alert condition when the controller determines that the difference indicates tampering with the camera.

37. The system of claim 32, wherein the controller determines whether the tampering is at least one of moving the camera, adjusting the camera, blocking at least a portion of a field of view of the camera, placing a substance on a lens of the camera or turning off the camera.

38. A security system, comprising:
at least one camera that provides an image;
a controller that determines whether a difference between at least a portion of a test image from the camera and a corresponding portion of a reference image from the camera indicates tampering with the camera; and
a memory containing a plurality of reference images associated with a plurality of different conditions and wherein the controller selects an appropriate one of the plurality of reference images corresponding to a condition associated with the test image.

39. The system of claim 38, wherein the conditions comprise times of day and the controller determines a time of day associated with the test image.

40. The system of claim 38, wherein the conditions comprise lighting conditions and the controller determines an expected one of the lighting conditions associated with the test image.

41. The system of claim 38, wherein the controller provides an indication of an alert condition when the controller determines that the difference indicates tampering with the camera.

42. The system of claim 38, wherein the controller determines whether the tampering is at least one of moving the camera, adjusting the camera, blocking at least a portion of a field of view of the camera, placing a substance on a lens of the camera or turning off the camera.
